(19) United States
(12) Patent Application Publication
(10) Pub. No.: US 2022/0019090 A1
(43) Pub. Date: Jan. 20, 2022

(54) Lineup Glasses

(71) Applicants: Jae Soo LEE, Federal Way, WA (US); Sarah Cho, Federal Way, WA (US)

(72) Inventors: Jae Soo LEE, Federal Way, WA (US); Sarah Cho, Federal Way, WA (US)

(21) Appl. No.: 16/930,055

(22) Filed: Jul. 15, 2020

(51) Int. Cl. G02C 7/02; A63B 69/36; G02C 7/10

(52) U.S. Cl. CPC G02C 7/021; G02C 7/10; A63B 69/3608

(57) ABSTRACT

Lineup glasses has a left lens connected to a right lens. One or both of the left lens and the right lens has a horizontal line and one or both of the left lens and the right lens may also have a vertical line that is perpendicular to the horizontal line. In addition, the horizontal line may have a plurality of horizontal spacing points and the vertical line may have a plurality of vertical spacing points.

The horizontal line and the vertical line on a lens create a virtual target line and a virtual vertical line, respectively, visible and could be superimposed over the golf ball and the ground so that the golfer could better align his stance, see a straight line between the ball and the target represented by the virtual target line, and to better estimate the distance between the ball and the target.

### SUMMARY

Lineup glasses suited for aligning directions for sports, including but not limited to golf, are presented herein. Although lineup glasses provided herein is mainly for sports, but the scope of the claims shall not be limited to sports, because other uses, including but not limited to scientific or engineering, are included in the scope of the claims presented.

In various sports, especially in golf, aligning oneself to the target, whether it is a flag or a hole, is one of the most essential element. It is not an overstatement to state that golf is a directional sport.

When a golfer selects a target and establishes a subjective target line, aligns oneself to that target line, and sets up to swing, much of the aligning is done by feeling based on the golfer's subjective target line. Thus, without much practice, the alignment of the golfer's feet and swing are often off the true target line to the target.

One of the most important and most commonly used stroke in golf is putting. A professional golfer uses about 40% of his or her strokes to the putting and an amateur golfer uses about 57% of his or her strokes to the putting. Perhaps this is the reason why even a professional golfers might state that putting is the most challenging part of golf. As in lining up to swing a golf club to send a ball towards the flag, the putting also requires the golfer to lineup to the golfer's subjective imaginary target line between the hole and the ball on the green. Because the alignment is made to an imaginary target line, the alignment for putting and for swinging are all subjective guesswork. Thus what appears to be the easiest part in the game of golf, the putting is perhaps the most difficult skill to master in golf.

Therefore, there is a need for a golfer to align himself or herself to the target, not only subjectively based on the imaginary target line, but also objectively based on a virtual target line from the ball to the target. The inventor believes a virtual target line from the ball to the target may be objectively achieved by a pair of lineup glasses as described herein.

Lineup glasses has two lenses connected to each other. A left lens is connected to a right lens. One or both of the left lens and the right lens has a horizontal line. The horizontal line may be drawn on the lens or may be imbedded in the lens. If the lenses are tinted, including but not limited to as in sunglasses or in transitional lenses, then a line may be a simple clear transparent line in the lens dividing the lens above the horizontal line and the lens below the horizontal line. The horizontal line parallels the ground when a user wears the lineup glasses and looks forward.

Lineup glasses are a part of a wearing means, such as an eyeglass frame as shown in the Figs. The wearing means, however, are not limited to an eyeglass frame, but also include various other wearing means. For example, commonly used wearing means may be an eyeglass clip mounted on an eyeglass frame, a string or a band of various materials attached to each end of the lenses, a mask with the lenses mounted on a front side of the mask.

One or both of the left lens and the right lens of the lineup glasses may also have a vertical line that is perpendicular to the horizontal line. The vertical line is perpendicular to the horizontal line, but the vertical line may or may not intersect the horizontal line.

The horizontal line has a plurality of horizontal spacing points and the vertical line has a plurality of vertical spacing points. Moreover, a preferred version of the lineup glasses is lenses with the horizontal line and the vertical line meet perpendicularly at an intersecting point so that the horizontal line extends left and right of the vertical line and the vertical line extends above and below the horizontal line. In addition, a preferred version of the lineup glasses is has a plurality of horizontal spacing points and a plurality of vertical spacing points. Either the lineup glasses having either or both the horizontal line and the vertical line on either or both of the lenses or the lineup glasses may be used pending the golfer's preference.

A preferred version of the lineup glasses has each of the horizontal lines having a plurality of horizontal spacing points and each of the vertical lines having a plurality of vertical spacing points. Moreover, The lineup glasses may have the left lens and the right lens that are tinted, ultraviolet (“UV”) radiation protected and glare resistant, as well as other commercially available eyeglass improvements, including but not limited to the lenses being transition lenses, transitioning their color, tint or opacity according to the surrounding conditions, including but not limited to light, temperature and UV radiation.

Some of the benefits of the lineup glasses, including but not limited to, are that (1) the golfer can see a virtual target line from the ball to the target, whether the target is a flag or a hole, and reduce the subjective guess work in the feet alignment and addressing the golf ball and (2) the golfer can align a putter to a virtual horizontal and virtual vertical line visible to the golfer as shown in Figs.

A variation to the lineup glasses may be made to the wearing means by having a frame accepting both the left lens and the right lens, and the frame having a right nose pad and a left nose pad such that either or both of the right nose pad and the left nose pad is rotatably attached to the frame using grooves. One or both of the nose pads may be rotated and fixedly secured by the grooves to better adjust the lineup glasses according to the preference of the golfer.

### BRIEF DESCRIPTION OF THE DRAWINGS

These and other features, aspects and advantages of the lineup glasses will become better understood with reference to the accompanying drawings, wherein:

FIG. 1: the lineup glasses with clear transparent lenses,

FIG. 2: the lineup glasses with tinted lenses,

FIG. 3: the lineup glasses with tinted lenses with their upper portions with darker tinting,

FIG. 4: a virtual target line and a virtual target line as seen by a golfer with a putter,

FIG. 5: a golfer looking down and addressing a golf ball while aligning to a virtual target line,

FIG. 6: a version of the lineup glasses with various spacing points marked,

FIG. 7: a golfer looking down and addressing a golf ball while aligning to a virtual target line and to a virtual vertical line,

FIG. 8: the lineup glasses formed in a clip that is attached to a frame,

FIG. 9: a rear perspective view of the lineup glasses showing rotatable nose pads, and

FIG. 10: an enlarged view of the rotatable nose pads with grooves.

### DETAILED DESCRIPTION EMBODIMENTS OF THE INVENTION

Lineup glasses are described in detail as shown on the Figs.

FIG. 1 shows the lineup glasses 10 with clear transparent lenses 15. Lineup glasses 10 has two lenses connected to each other. A left lens 20 is connected to a right lens 25. One or both of the left lens 20 and the right lens 25 has a horizontal line 30. The horizontal line 30 may be drawn on the lens 15 or may be imbedded in the lens 15. If the lenses 15 are tinted, including but not limited to as in sunglasses or in transitional lenses, then the horizontal line 30 may be a simple clear transparent line in the lens dividing the lens above the horizontal line 30 and the lens below the horizontal line 30. The horizontal line 30 parallels the ground when a user 35 (shown in FIG. 5) wears the lineup glasses 10 and looks forward or looks down on the ground.

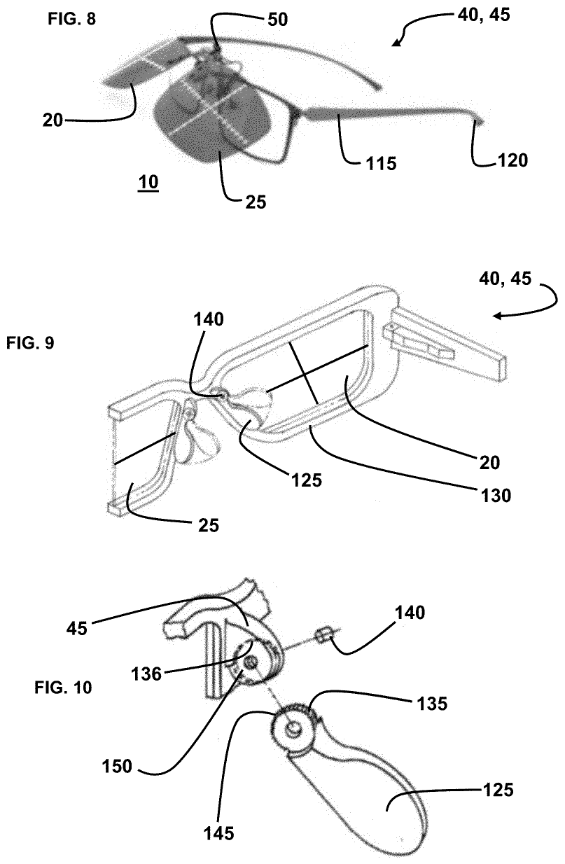

Lineup glasses 10 are a part of a wearing means 40, such as an eyeglass frame 45 as shown in the Figs. The wearing means 40, however, are not limited to an eyeglass frame 45, but also include various other wearing means. For example, commonly used wearing means may be an eyeglass clip 50 (as shown in FIG. 8) mounted on an eyeglass frame 45, a string or a band of various materials attached to each end of the lenses 15, a mask with the lenses 15 mounted on a front side of the mask.

One or both of the left lens 20 and the right lens 25 of the lineup glasses 10 may also have a vertical line 55 that is perpendicular to the horizontal line 30. The vertical line 55 is perpendicular to the horizontal line 30, but the vertical line 55 may or may not intersect the horizontal line 30. For example, the vertical line 55 may be above the horizontal line 30 or below the horizontal line 30 or have more than one shorter vertical lines one on each side of the lens 15. Alternatively, the vertical line 55 may start from or end at the horizontal line 30, having the vertical line 55 only on one side of the horizontal line 30. A preferred version of the lineup glasses 10 is that each lens 15 with the horizontal line 30 and the vertical line 55 meet perpendicularly at an intersecting point 60 so that the horizontal line 30 extends left and right of the vertical line 55 and the vertical line 55 extends above and below the horizontal line 30.

The horizontal line 30 may have a plurality of horizontal spacing points 65 and the vertical line 55 may have a plurality of vertical spacing points 70. A preferred version has the horizontal spacing points 65 spaced equally apart on the horizontal line 30 and the vertical spacing points 70 spaced equally apart on the vertical line 55. Also, a preferred version has the horizontal spacing points 65 starting from the intersecting point 60 and are spaced equally apart on the horizontal line 30 and the vertical spacing points 70 starting from the intersecting point 60 and are spaced equally apart on the vertical line 55. An alternate version of the lineup glasses 10 may be available with either or both the horizontal spacing points 65 and the vertical spacing points 70 gradually increase the spacing or gradually decrease the spacing proportional to the height of the user, the golfer, or the radial effect as the objects or portions of the ground farther away from the pupil of the user's eye. For ease of seeing the horizontal spacing points 65 and the vertical spacing points 70, the horizontal spacing points 65 and the vertical spacing points 70 may be presented as bars perpendicular to their respective lines as shown; a bar is a short line that intersects the horizontal line 30 or the vertical line 55 at the horizontal spacing points 65 or the vertical spacing points 70 for marking the horizontal spacing points 65 and/or the vertical spacing points 70. The horizontal spacing points 65 and/or the vertical spacing points 70 may be also marked with dots on each of the horizontal spacing point 65 and/or the vertical spacing points 70.

Although the Figs. show the horizontal line 30 and the vertical line 55 are on both lenses, the horizontal line 30 and the vertical line 55 may be placed only on one of two lenses 15; if so, preferably for the dominant eye of the user.

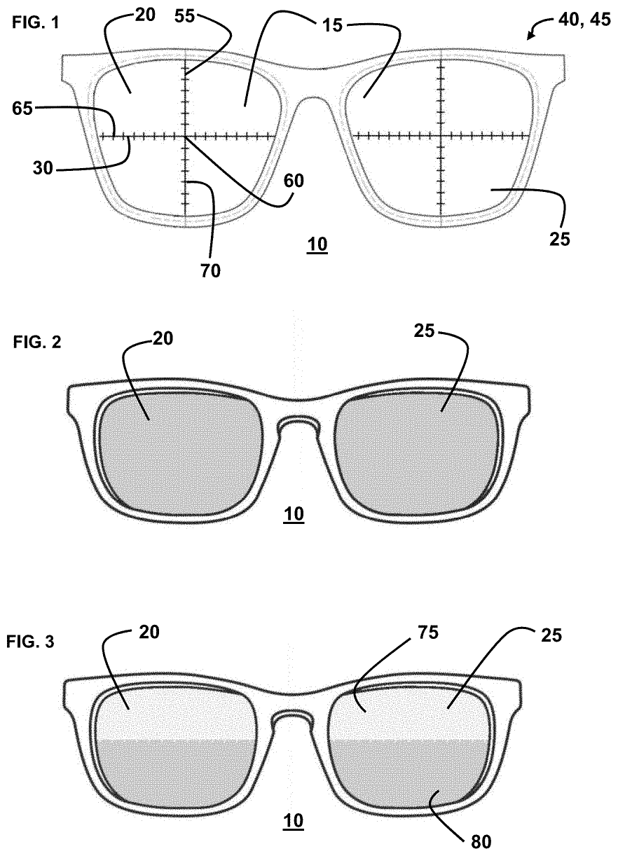

FIG. 2 shows the lineup glasses 10 with tinted lenses 15 used as sunglasses. In addition, the lenses 15 may be ultraviolet (“UV”) radiation protected, glare resistant, and/or bi-focal, as well as manufactured or treated to have other commercially available eyeglass improvements, including but not limited to the lenses 15 being transition lenses, transitioning their color, tint or opacity according to the surrounding conditions, including but not limited to light, temperature and UV radiation. Also variation of tint may be from the different colors used for the lenses 15.

FIG. 3 shows the lineup glasses 10 with tinted lenses 15 with their upper portions 75 with darker tinting than that of their lower portions 80. Although the upper portions 75 of the lenses 15 are shown to have darker tinting and the lower portions 80 of the lenses 15 are shown to have lighter tinting, it is possible to the lower portion 80 of the lenses 15 be darker than the upper portion 75 of the lenses 80. Also the contrast between the upper portion 75 and the lower portion 80 may be achieved by only the upper portion 75 is tinted and the lower portion 80 is clear, and vice versa. As mentioned above, different tinting may be achieved by using different color shading for the lenses 15. Also, as seen on FIG. 3, the use of the vertical lines 55 is optional.

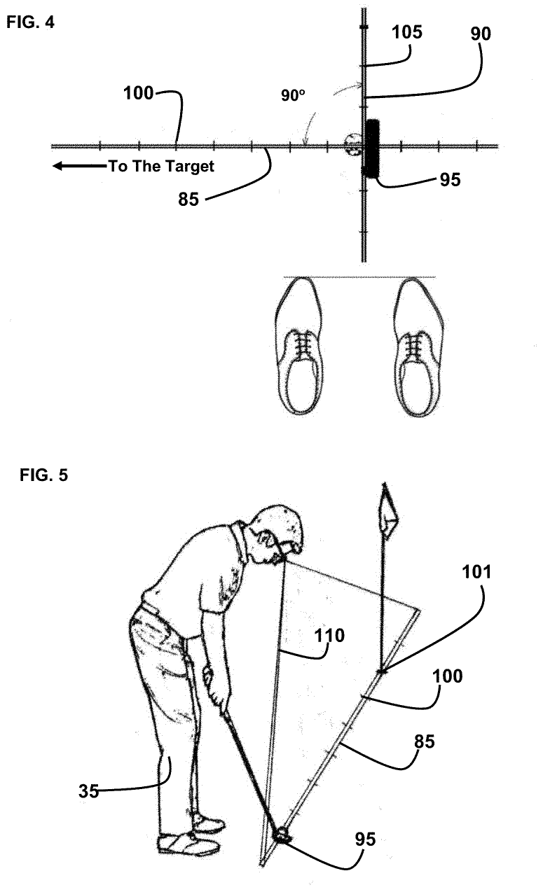

FIG. 4 shows a virtual target line 85 and a virtual vertical line 90 as seen by a golfer with a putter 95. The virtual target line 85 and the virtual vertical line 90 are generated by the horizontal line 30 and the vertical line 55, respectively, in the view of the user and they are seen by the user as the user views through the lineup glasses 10. The virtual vertical line 90 created by the vertical line 55 on the lens 15 is perpendicular to the virtual target line 85 created by the horizontal line 30 on the lens 15 are visible and superimposed over the golf ball and the ground, the putting green for putting or on the field for swing.

One may readily see and understand the benefits of the lineup glasses 10 as the user aligns the feet parallel to the virtual target line 85 and aligns the putter face with the virtual vertical line 90. Moreover, the user could make putting simplified because he could focus on making his putting stroke to simply follow along the visible virtual target line 85. Having and being able to see a visible virtual target line 85 aligned to the hole or to a target point as he putts or swings would make it much easier to make his putting stroke straight (or the swing on line to the target line), smooth and to have a much better follow through, helping to make putts more successful. Also for putting, the user may use a ball with a line on it to align also the line on the ball with the virtual target line.

One unseen benefit of the lineup glasses 10 is that the lineup glasses 10 gives confidence to the golfer that he is lined up well to the hole and that his swing or putting is actually on the virtual target line 85. The user can actually see the swing path or the putting path as he or she makes the swing, especially if he does not rotate his or her head during his swing. This is most evident during his or her putting.

FIG. 4 also shows a plurality of virtual horizontal spacing points 100 on the virtual target line 85 and a plurality of virtual vertical spacing points 105 on the virtual vertical line 90. One advantage in able to see the virtual horizontal spacing points 100 is that the user may better estimate the distance between the ball and the target or the hole. With practice, the distance between the ball and the hole, especially for putting, can be accurately estimated rather than having a subjective guesstimate. One can readily agree that having a more accurate estimate from the ball to the hole would give the golfer an advantage in putting.

FIG. 5 shows a golfer 35 looking down and addressing a golf ball while aligning to a virtual target line 85 pointing to a target 101, a flag of a hole as shown. The golfer is looking down at the ball, indicated by a sight line 110 on FIG. 5. FIG. 5 shows the plurality of virtual horizontal spacing points 100 on the virtual target line 85 that is aligned between the ball and the hole, showing that the hole is six virtual horizontal spacing points 100 away from the ball. With practice, the user will be accurately know the distance between the ball and the hole from the number of virtual horizontal spacing points 100 from the ball to the hole.

One should note that the each virtual horizontal spacing point 100 on the green may indicate increasing distance between two virtual horizontal spacing points 100 as the virtual horizontal spacing points 100 are further away from the ball due to slightly increasing angle of the eye to the hole. This difference may also be compensated by the user in his or her calculation with practice.

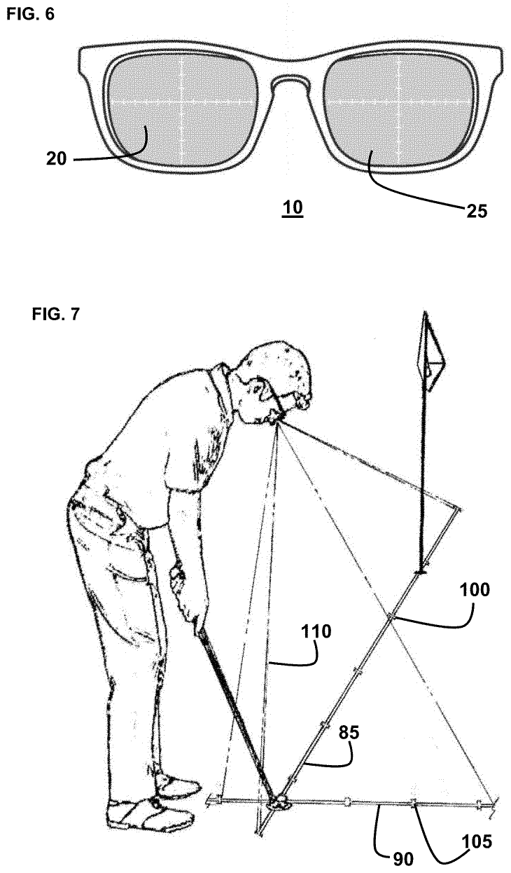

FIG. 6 shows a version of the lineup glasses 10 with both the horizontal spacing points 65 on the horizontal line 30 and the vertical spacing points 70 on the vertical line 55.

FIG. 7 shows the golfer looking down and addressing a golf ball while aligning to the virtual target line 85 and to a virtual vertical line 90. The virtual target line 85 shows the plurality of virtual horizontal spacing points 100 and the virtual vertical line shows the plurality of virtual vertical spacing points 105.

FIG. 8 shows the lineup glasses 10 formed with a clip 50 that is attached rotatably and removably to a frame 45 having temples 115 and temple tips 120.

FIG. 9 is a rear perspective view of the lineup glasses 10 showing rotatable nose pads 125 on the frame 45. The left lens 20 and the right lens 25 are mounted on rims 130 of the frame 45.

FIG. 10 is an enlarged view of the rotatable nose pads 125 with grooves 135. The rotatable nose pads 125 with grooves 135 can be rotatably and fixedly attached to the frame 45. The frame would have matching grooves 136 so the grooves 135 of the nose pads 125 will firmly engage the matching grooves of the frame by a pin or a screw 140. One or both of the nose pads 125 may be rotated and fixedly secured by the grooves 135 to better adjust the lineup glasses 10 according to the need and/or the preference of the golfer, and to adjust the lineup glasses to fit the nose of the user. Although the grooves 135 on the nose pads 125 are shown on the ends 145 of the nose pads 125, the grooves 135 may be placed on contacting sides of a nose pad (grooves on the contacting sides of the nose pads are not shown in FIG. 10 as they would be underneath the side shown in FIG. 10) to rotatably and fixedly attached to a contacting part 150 of frame 45. The contacting part 150 of frame 45 that accepts the grooves on the nose pads may also have the matching grooves or may be made of softer material than the grooves of the nose pads 125.

It should be apparent that one or both of the left lens 20 and the right lens 25 of the lineup glasses 10 may have a vertical line 55 without a horizontal line 30.

While the description, drawings and references have presented, shown and described with reference to different embodiments thereof, it will be appreciated by those skilled in the art that variations in form, detail, compositions and operation may be made without departing from the spirit and scope of the disclosure.

What is claimed is:

1. Lineup glasses having a left lens connected to a right lens, wherein the left lens or the right lens has a horizontal line that parallels the ground when a user wears the lineup glasses and looks forward, and wherein the left lens and the right lens are attached to a wearing means.

2. The lineup glasses of claim 1 wherein the left lens or the right lens having the horizontal line also has a vertical line that is perpendicular to the horizontal line.

3. The lineup glasses of claim 1 wherein the horizontal line has a plurality of horizontal spacing points.

4. The lineup glasses of claim 2 wherein the horizontal line has a plurality of horizontal spacing points.

5. The lineup glasses of claim 4 wherein the vertical line has a plurality of vertical spacing points.

6. The lineup glasses of claim 2 wherein the horizontal line and the vertical line meet perpendicularly at an intersecting point, wherein the horizontal line extends left and right of the vertical line and the vertical line extends above and below the horizontal line.

7. The lineup glasses of claim 6 wherein the horizontal line has a plurality of horizontal spacing points.

8. The lineup glasses of claim 7 wherein the vertical line has a plurality of vertical spacing points.

9. Lineup glasses having a left lens connected to a right lens, wherein each of the left lens and the right lens has a horizontal line that parallels the ground when a user wears the lineup glasses and looks forward, and wherein the left lens and the right lens are attached to a wearing means.

10. The lineup glasses of claim 9 wherein each of the left lens and the right lens has a vertical line that is perpendicular to the horizontal line.

11. The lineup glasses of claim 9 wherein each of the horizontal lines has a plurality of horizontal spacing points.

12. The lineup glasses of claim 10 wherein each of the horizontal lines has a plurality of horizontal spacing points and each of the vertical lines has a plurality of vertical spacing points.

13. The lineup glasses of claim 10 wherein the horizontal line and the vertical line on the left lens meet perpendicularly at a left intersecting point, wherein the horizontal line and the vertical line on the right lens meet perpendicularly at a right intersecting point, wherein the horizontal line of the left lens extends left and right of the vertical line of the left lens and the vertical line of the right lens extends above and below the horizontal line of the right lens.

14. The lineup glasses of claim 13 wherein each of the horizontal lines has a plurality of horizontal spacing points.

15. The lineup glasses of claim 14 wherein each of the vertical lines has a plurality of vertical spacing points.

16. The lineup glasses of claim 9 wherein the wearing means is a frame that accepts both the left lens and the right lens.

17. The lineup glasses of claim 16 wherein the left lens and the right lens are tinted.

18. The lineup glasses of claim 17 wherein left lens and the right lens have different tint above and below their respective horizontal lines.

19. The lineup glasses of claim 18 wherein the wearing means comprises of a clip connecting the left lens and the right lens, wherein the clip is removably and rotatably attached to a frame.

20. The lineup glasses of claim 17 wherein the wearing means is a frame that accepts both the left lens and the right lens, wherein the frame has a right nose pad and a left nose pad, and wherein either or both of the right nose pad and the left nose pad is rotatably attached to the frame.
